(19) United States
(12) Patent Application Publication
(10) Pub. No.: US 2015/0359242 A1
(43) Pub. Date: Dec. 17, 2015

(54) REDUCED SUGAR CONFECTIONARIES

(71) Applicant: Tate & Lyle Ingredients Americas, LLC, Hoffman Estates, IL (US)

(72) Inventors: Sanjiv H. AVASHIA, Stremwood, IL (US); Jodi L. BALDWIN, Decatur, IL (US); Rohit A. MEDHEKAR, Schaumburg, IL (US); Judy Lynn TURNER, Hoffman Estates, IL (US)

(73) Assignee: TATE & LYLE INGREDIENTS AMERICAS, LLC, Hoffman Estates, IL (US)

(21) Appl. No.: 14/764,023

(22) PCT Filed: Jan. 24, 2014
(86) PCT No.: PCT/US2014/012869

§ 371 Date: Jul. 28, 2015

Related U.S. Application Data
(60) Provisional application No. 61/757,983, filed on Jan. 29, 2013.

(51) Int. Cl. A23G 3/32; A23L 1/236; A23L 1/307; A23G 3/42; A23L 1/09

(52) U.S. Cl. CPC A23G 3/32; A23G 3/42; A23L 1/09; A23L 1/307; A23L 1/2363; A23V 2002/00

(57) ABSTRACT

A reduced sugar corn syrup (RSCS) and at least one of a reducing saccharide or a thinboiling starch are used as ingredients for the preparation of food products such as caramels, chewy confectionaries, jelly gum confectionaries, bakery and confectionary fillings, flavored syrups, ice cream variegates, dessert toppings and the like.

### FIELD OF THE INVENTION

The present invention pertains to the formulation and manufacture of confectionaries having a reduced content of sugar, as compared to conventional confectionaries.

### BACKGROUND OF THE RELATED ART

There is a current desire to reduce the level of sugar (mono- and disaccharides) in food products, especially in products that are usually very high in sugar, such as jelly (soft) gum confectionaries, caramels, chewy confectionaries, bakery and confectionary fillings, flavored syrups, ice cream variegates, dessert toppings and other sweets. For many years, food technologists have sought to reduce sugar and/or calories in a wide range of foods.

Reduced sugar corn syrup (RSCS), which has recently been developed, is an innovative syrup derived from corn that has reduced levels of mono- and disaccharides as compared to conventional corn syrups (as used herein, a “conventional corn syrup” is a sweetener syrup obtained by hydrolysis of corn starch which has a high content of mono- and disaccharides, i.e., at least 40% by weight on a dry solids basis). Reduced sugar corn syrups are described, for example, in U.S. Pat. Publication 2013/0197104, the disclosure of which is incorporated herein by reference in its entirety for all purposes). RSCS facilitates the formulation of many types of food products with significantly reduced levels of sugar. However, RSCS, as a consequence of its lower sugar levels, is not quite as sweet as conventional corn syrups (as used herein, a “conventional corn syrup” is a sweetener syrup obtained by hydrolysis of corn starch which has a high content of mono- and disaccharides, i.e., at least 40% by weight on a dry solids basis). In addition, it has been found that RSCS is not suitable as a direct replacement for conventional corn syrups in food products in which the corn syrup is included for the purpose of aiding in caramelization, browning and/or flavor development (e.g., the development of a caramel flavor) in the food product during processing (cooking, baking), among other possible purposes. One such food product is caramel.

Caramel can be prepared using a mixture of sucrose and a conventional corn syrup, such as STALEY® 1300 or SWEETOSE® 4300, together with any other desired caramel ingredients such as sweetened condensed milk, milk, cream, milk solids, butter, lecithin, salt, flavorings and so on.

It was observed that caramel made with RSCS was harder and less sweet than control caramel made with 63 dextrose equivalent (DE) corn syrup. For example, a 1:1 replacement of conventional high sugar corn syrups such as STALEY® 1300 (43 DE) or SWEETOSE® 4300 (63 DE) with an RSCS provided a caramel with excessive hardness under identical formulation and processing conditions.

Therefore, it would be desirable to develop a caramel with reduced-sugar content (as a result of the inclusion of a RSCS in the caramel formulation) that nonetheless reproduces all the desired texture, color, flavor, and overall organoleptic experience of a traditional high-sugar caramel. We have now found that this can be achieved by partially replacing the sucrose (a non-reducing disaccharide) in the caramel formulation with a reducing saccharide such as fructose. Furthermore, addition of a reducing saccharide was discovered to not only reduce the glass transition temperature of the RSCS-formulated caramel, but also to impart an added sweetness and desired browning to the caramel. The caramel also exhibits the desirable texture, color, flavor, and overall organoleptic experience of traditional high-sugar caramels (i.e., caramel made using conventional corn syrups).

Jelly (soft) gum confectionaries such as gum drops, spice drops, orange or other fruit-flavored slices, spearmint leaves, jubes and jelly centers such as jelly bean centers are conventionally made by cooking a mixture of conventional corn syrup, sucrose and thin-boiling starch (which functions as a gelling agent in the confectionary), combining the cooked mixture with acidulants, flavorants and/or colorants, placing the mixture in molds, and then drying the molded mixture until a desired water content or firmness (gel strength) is achieved before demolding the jelly gum confectionaries. This drying step, using traditional ingredients, takes an extended period of time (i.e., about two days) before the confectionaries attain a degree of firmness, gel strength and dimensional stability that allows them to be demolded and then subjected to further processing (e.g., sanding with sugar, packaging). We have now discovered that the time required in such a process to attain a certain moisture content (which is reflected in the drying rate) and/or the time required to reach a certain firmness or gel strength (which may be independent of the actual moisture content of the molded confectionary) can be significantly shortened by substituting a reduced sugar corn syrup (RSCS) for all or a part of the conventional corn syrup component of a jelly gum confectionary formulation. This reduction of the drying time (increase in drying rate) and/or reduction of the time required to attain a predetermined level of firmness permits confectionary manufacturers to decrease cycle times, increase productivity, and reduce costs, with the final product having the additional advantage of being lower in sugar content than a conventional jelly gum confectionary made using a full-sugar corn syrup while still having the texture, color, flavor and other organoleptic qualities desired for a jelly gum confectionary.

### BRIEF SUMMARY OF THE INVENTION

According to a first aspect, the present invention provides a blend comprising a reduced sugar corn syrup (RSCS) and at least one of a reducing saccharide or a thin-boiling starch. Optionally, the blend may additionally comprise sucrose and/or one or more other food ingredients. Such blends are useful in the preparation of confectionaries. Thus, one embodiment of the invention provides a confectionary comprised of a reduced sugar corn syrup (RSCS), at least one of a reducing saccharide or a thin-boiling starch, and at least one additional food ingredient (e.g., sucrose, high potency sweeteners, milk-derived ingredients, emulsifiers, flavorants, colorants, acidulants, conventional corn syrup and the like).

According to another embodiment, the RSCS is a syrup comprising water and saccharides, the saccharides having a saccharide distribution so as to provide a DP1+DP2 content of about 10% to about 30% (e.g., about 10% to about 25%), a DP3-11 content of about 65% to about 90% (e.g., about 70% to about 90%), and a DP11+ content of 0% to about 15%, the total equaling 100%. For example, the RSCS may comprise water and saccharides, the saccharides having a saccharide distribution of DP1 1-4%; DP2 10-15%; DP3 9-13%; DP4 7-11%; DP5 6-10%; DP6 13-19%; DP7 12-17%; DP8 4-7%; DP9 3-7%; DP10 2-6%; DP11 7-15%; DP11+ 0-4%, the total equaling 100%.

According to one embodiment, the reducing saccharide is fructose. For example, the reducing saccharide may be a fructose supplied in crystalline, liquid and/or powdered form. Illustrative examples of suitable commercially available sources of fructose include KRYSTAR® crystalline fructose, such as KRYSTAR® 300, 300U, or KRYSTAR® 450, liquid KRYSTAR® fructose and powdered KRYSTAR® fructose. In addition to enhancing the caramelization characteristics of a confectionary formulation containing RSCS, the fructose helps to increase the sweetness of the confectionary produced therefrom.

The weight ratio of RSCS to reducing saccharide may be, for instance, from about 50:50 to about 75:25 or from about 40:60 to about 25:75. For example, the weight ratio of RSCS to reducing saccharide may be about 50:50.

According to a further aspect, the present invention provides the use of the above-mentioned blends for the preparation of jelly gum confectionaries, caramels, chewy confectionaries, bakery and confectionary fillings, flavored syrups, ice cream variegates, dessert toppings and the like.

According to a further aspect, the present invention provides the use of a reduced sugar corn syrup (RSCS) and a reducing saccharide in the preparation of caramels, chewy confectionaries, bakery and confectionary fillings, flavored syrups, ice cream variegates, dessert toppings and the like.

According to a further aspect, the present invention provides the use of a reduced sugar corn syrup (RSCS) and a thin-boiling starch in the preparation of jelly gum confectionaries and the like. A method of reducing the drying time and/or time to a preselected level of firmness of a jelly gum confectionary formulation comprised of a sweetener syrup component and a thin-boiling starch is also provided by the present invention, wherein the method comprises utilizing a reduced sugar corn syrup as at least a portion of the sweetener syrup component. The sweetener syrup component may comprise, in addition to the RSCS, one or more conventional corn syrups. In various aspects of the invention, the sweetener syrup component may comprise at least 50% by weight, at least 60% by weight, at least 70% by weight, at least 80% by weight, at least 90% by weight, or even 100% by weight RSCS on a dry solids basis, the balance to 100% being one or more conventional corn syrups.

According to a further aspect, the present invention provides a caramel made using a blend comprised of an RSCS and a reducing saccharide, and/or made using the RSCS and the reducing saccharide as individual ingredients.

According to a further aspect, the present invention provides a jelly gum confectionary, a chewy confectionary, a bakery filling, a confectionary filling, a flavored syrup, an ice cream variegate or a dessert topping made using the aforementioned blend and/or made using the RSCS and at least one of the reducing saccharide or the thin-boiling starch as individual ingredients.

According to a further aspect, the present invention provides a method for the preparation of a reduced sugar caramel comprising heating a mixture comprised of a) at least one ingredient selected from the group consisting of milk, cream and butter, b) an RSCS and c) a reducing saccharide. The mixture may additionally comprise sucrose (in addition to any sucrose present in the RSCS). In one embodiment of the invention, the mixture exhibits a greater degree of caramelization during heating than an analogous mixture not comprising the reducing saccharide.

A method of increasing the propensity of a confectionary formulation comprised of a reduced sugar corn syrup to caramelize when cooked is provided in a still further aspect of the invention, wherein the method comprises including at least one reducing saccharide such as fructose in the confectionary formulation.

Still another aspect of the invention furnishes a method of preparing a blend useful for producing a confectionary, wherein the method comprises combining a reduced sugar corn syrup with at least one of a reducing saccharide or a thin-boiling starch to obtain the blend. One or more additional food ingredients may be combined with the RSCS and the reducing saccharide and/or thin-boiling starch to produce the blend, if so desired.

It is envisaged that the present invention will have broad application in the production of confectionaries that traditionally are formulated with high levels of sugar, such as caramels, chewy confectionaries, jelly gum confectionaries and the like.

### DESCRIPTION OF THE FIGURE

FIG. 1 illustrates the drying rates observed for the various jelly gum confectionaries prepared as described in Example 8.

### DESCRIPTION OF THE INVENTION

The term, “DPN,” as used herein, refers to the degree of polymerization, where N is the number of monomeric units (i.e., glucose or dextrose units) in the saccharide; thus, DPN reflects the composition of the saccharide. For example, DP1 is a monosaccharide; DP2 is a disaccharide; DP1+2 is the total of mono- and disaccharides; DP3-11 is the total of DP3 to DP11; and DP11+ is the total of saccharides containing more than 11 monomeric units per molecule. DPN is expressed as a weight percent of an individual saccharide on a total saccharide dry weight basis. The DPN composition of a product is determined using high performance liquid chromatography (HPLC). Samples are diluted to approximately 5% solids with Milli-Q water and filtered through a 0.45 μm filter. Twenty microliters of sample are injected. The separation is accomplished using a Bio-Rad HPX 42A column, a styrene divinyl benzene resin based column in the silver form coupled with a refractive index detector. The 42A column is more lightly cross-linked than the columns used to analyze HFCS (high fructose corn syrup). The lower cross linking gives the resin an open structure, making it more permeable to higher molecular weight structures. That coupled with the ligand-ligand reaction between the silver counter ion on the resin and the hydroxyl groups on the sugars allows separation up to DP 12 with a run time of less than 20 minutes. Quantitation is done using area percent with no response factors since there are few commercially available pure sugar standards above maltopentose. The refractive index responses for all these sugars is expected to be very similar.

The term, “DS,” as used herein, refers to the percent dry solids of a substance as determined using the computer program, Refractive Index Dry Substance (RI-DS), Standard Analytical Method E-54, Corn Refiners Association, 6^{th} Edition, 1977, E-54, pp. 1-11.

The term “sugar,” as used herein, refers to mono- and/or disaccharides.

The term, “syrup,” as used herein, refers to aqueous solutions of saccharides.

The term, “viscosity,” as used herein, refers to the resistance of a fluid to flow. The viscosity of a syrup is typically affected by temperature and solids concentration. Viscosity is expressed in terms of poise (P) or centipoise (cps) at a given temperature and a given % DS.

The present invention provides the use of a blend comprising a reduced sugar corn syrup (RSCS) and a reducing saccharide for the preparation of caramels, chewy confectionaries, and the like. The reducing saccharide replaces a portion of the sucrose normally used when preparing caramels, chewy confectionaries and the like. Thus, the blend may optionally also comprise one or more additional food ingredients such as sucrose (in addition to the quantity of sucrose that may be contributed to the blend as a component of the RSCS).

The present invention further provides the use of a blend comprising a reduced sugar corn syrup (RSCS) and a thin-boiling starch for the preparation of jelly gum confectionaries and the like.

The present invention also provides a blend comprising a reduced sugar corn syrup (RSCS) and a reducing saccharide, in particular fructose, as well as a blend comprising a reduced sugar corn syrup (RSCS) and a thin-boiling starch. These blends may contain, as optional additional ingredients, one or more further food ingredients (e.g., confectionary ingredients), such as sucrose, high potency sweeteners and the like.

The present invention also provides a caramel made using the above blend comprised of RSCS and reducing saccharide, and/or made using the RSCS and the reducing saccharide as individual ingredients (rather than as a pre-prepared blend). Also provided by the present invention is a jelly gum confectionary made using the above blend comprised of RSCS and thin-boiling starch, and/or made using the RSCS and the thin-boiling starch as individual ingredients (rather than as a pre-prepared blend).

The present invention also provides chewy confectionaries made using a blend comprised of RSCS and reducing saccharide, and/or made using the RSCS and the reducing saccharide as individual ingredients (rather than as a pre-prepared blend).

In certain embodiments of the present invention, the reduced sugar corn syrup (RSCS) is a syrup comprising water and saccharides, the saccharides having a saccharide distribution so as to provide a DP1+DP2 content of about 10% to about 30%, a DP3-11 content of about 65% to about 90%, and a DP11+ content of 0% to about 15%, the total equaling 100% (all on a dry solids basis). In other embodiments of the present invention, the reduced sugar corn syrup (RSCS) is a syrup comprising water and saccharides, the saccharides having a saccharide distribution so as to provide a DP1+DP2 content of about 10% to about 25%, a DP3-11 content of about 70% to about 90%, and a DP11+ content of 0% to about 15%, the total equaling 100% (on a dry solids basis). Advantageously, the syrup may have a viscosity of not more than about 1400 poise at 20° C. when the syrup has a dry solids content of 80%.

In one embodiment, the saccharides present in the RSCS have a saccharide distribution so as to provide a DP4 content of at least about 35% and a content of less than about 6% with respect to each of DP5 to DP10, on a dry solids basis.

In other embodiments, the saccharides have a saccharide distribution so as to provide a DP11+ content of not more than 10% or not more than 5%, on a dry solids basis.

In another embodiment, the reduced sugar corn syrup comprises water and saccharides, the saccharides having a saccharide distribution of DP1 1-4%; DP2 10-15%; DP3 9-13%; DP4 7-11%; DP5 6-10%; DP6 13-19%; DP7 12-17%; DP8 4-7%; DP9 3-7%; DP10 2-6%; DP11 7-15%; DP11+ 0-4%, the total equaling 100% on a dry solids basis.

The reduced sugar corn syrup may be formulated to contain a small amount of one or more natural high potency sweeteners. Artificial (synthetic) high potency sweeteners may also be used. Alternatively or additionally, one or more natural and/or artificial high potency sweeteners may be incorporated into the reduced sugar confectionaries of the present invention as individual ingredients, rather than as part of the RSCS component.

Suitable natural high potency sweeteners include, but are not limited to, substances such as mogrosides (e.g., mogroside V) as well as extracts containing one or more mogrosides such as monk fruit (Luo Han Guo) extracts, steviol glycosides such as steviosides and rebaudiosides (e.g., rebaudioside A, rebaudioside B, rebaudioside C) as well as extracts containing one or more steviol glycosides such as Stevia extracts), glycosylated steviol glycosides (such as those obtained by enzymatic glycosylation of mixtures of semi-purified steviol glycosides), rubusoside (which may be supplied in the form of a Rubus extract), and the like and combinations thereof. Other exemplary suitable high potency sweeteners useful in the present invention include natural and artificial substances such as neohesperidin dihydrochalcone, neotame, glycyrrhizin and its salts and derivatives (e.g., ammoniated glycyrrhizin), aspartame, saccharin, thaumatin, monatin, sucralose, acesulfame potassium and the like and mixtures thereof (including combinations with any of the aforementioned natural high potency sweeteners).

The RSCS may be produced by contacting a starch or starchy material with a first alpha amylase enzyme in an aqueous medium for a time effective to hydrolyze the starch or starchy material to provide a reaction product having a saccharide distribution having a DP1+DP2 content of about 10% to about 30% (or about 10% to about 25%), a DP3-11 content of about 65% to about 90% (or about 70% to about 90%, and a DP11+ content of 0% to about 15%, the total equaling 100%. The first alpha amylase enzyme may be a polypeptide encoded by a nucleic acid having at least 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more, or complete (100%) sequence identity to GenBank Accession No. AF504065 or an amino acid sequence comprising an enzymatically active fragment of said polypeptide.

In one advantageous method, a slurry of the starch or starchy material, aqueous medium and first alpha amylase enzyme is initially jet cooked at a first temperature of from about 100° C. (212° F.) to about 115° C. (239° F.) and then maintained at a second temperature of from about 80° C. (176° F.) to about 95° C. (203° F.) for a time effective to provide the desired reaction product. In one embodiment, the only type of enzyme used in the method of producing the reduced sugar corn syrup is alpha amylase.

The starch or starchy material or the liquefied starch mixture may be additionally contacted with a maltotetragenic alpha amylase, such as a variant of a Pseudomonas saccharophilia maltotetraohydrolyase. Using a combination of these different enzymes in this manner achieves hydrolysis of the starch or starchy material in a manner which helps to minimize the formation of sugars (DP1+2) and higher oligosaccharides (DP11+) while maximizing the content of DP4 in the resulting syrup.

The reducing saccharide is advantageously a reducing monosaccharide such as fructose, although other reducing saccharides may also be contemplated. A reducing saccharide (also sometimes referred to as a reducing sugar) is a sugar that has an aldehyde group or a ketone group that is capable of forming an aldehyde group through isomerization. Other suitable reducing saccharides may include, for example, reducing monosaccharides such as glucose, glyceraldehyde, mannose, xylose and galactose and reducing disaccharides such as lactose and maltose. Mixtures or combinations of different reducing saccharides may be utilized. Generally speaking, however, the use of large amounts of reducing saccharides having a propensity to crystallize from solution, such as glucose, is to be avoided, where such crystallization may have adverse or undesirable effects on the organoleptic attributes of the confectionary made therefrom. The reducing saccharide used can be in any known form and from any available source. In the case of the blend of the present invention which comprises RSCS and reducing saccharide, a liquid fructose is preferably used, such as the liquid fructose sold under the brand name KRYSTAR®. In the case where the fructose and RSCS are used as separate ingredients, rather than as a pre-prepared blend, then essentially any suitable form of fructose may be used, including crystalline, powdered and liquid forms. Particular examples of commercially available types of fructose which may be used are KRYSTAR® crystalline fructose, such as KRYSTAR® 300 or 300U, or KRYSTAR® 450, liquid KRYSTAR®, and powdered KRYSTAR®.

In one embodiment of the blend comprised of RSCS and reducing saccharide according to the present invention, the weight ratio (on a dry weight basis) of RSCS to reducing saccharide is from about 50:50 to about 75:25 for firmer yet pliable texture. Alternatively, the weight ratio may be from about 40:60 to about 25:75 for increasing plasticity and sweetness of the finished product. Preferably, the ratio can be tailored to achieve a range of texture from firm and chewy to soft and pliable. Up to 75% of sugar (sucrose) in a formula containing a combination of sugar (sucrose) and RSCS corn syrup can be replaced by fructose on dry solids basis to decrease the hardness of high solids confectionary formulas, such as caramels. The introduction of fructose in such a formula also provides the benefit of enhancing the ability of the formula to undergo caramelization when heated (cooked), especially in the presence of a milk-derived ingredient (e.g., milk, cream, butter).

The blend comprised of RSCS and reducing saccharide according to one aspect of the present invention offers the following advantages: (1) lower viscosity than analogous formulations using low DE syrups; (2) lower glass transition temperature (or a glass transition temperature equal to 63 DE syrup); (3) reduced sugar content (permitting the confectionary to be labeled as such); (4) better browning and caramelization effects than sucrose-based formulations and; (5) imparting sweetness to RSCS in a label friendly manner.

The blend comprised of RSCS and reducing saccharide according to one aspect of the present invention can be used to make caramels and reduced sugar confectionaries such as chewy confectionaries, caramels, bakery fillings, confectionary fillings, and the like in which a conventional corn syrup is used in combination with one or more mono and/or disaccharides. In this case, the blend is typically used to replace a traditional corn syrup in a mixture for producing a caramel, chewy confectionary, or the like. The amount of sucrose in the mixture is then reduced accordingly, for example by about 25 wt %, or about 50 wt %, or any other appropriate amount, compared to the amount of sucrose which would have been used with a conventional corn syrup or syrups. The extent to which the amount of sucrose is reduced will obviously depend on the composition of the blend, and particularly on its content of reducing saccharide.

As an alternative to using the blend comprising RSCS and reducing saccharide according to one aspect of the present invention, the RSCS and the reducing saccharide may be added as separate ingredients when preparing a reduced sugar confectionary. In this case, the RSCS will typically replace the conventional corn syrup(s), and the reducing saccharide will replace a portion of the sucrose. The portion of the sucrose replaced can vary according to requirements, and may be about 25 wt %, or about 50 wt %, or any other appropriate amount.

A reduced sugar caramel of the present invention can be prepared using any known method for manufacturing caramel. In one or more embodiments, a reduced sugar caramels can be prepared by mixing the necessary ingredients with one or more milk-derived components selected from butter, milk (which may be supplied, for example, in the form of milk solids, sweetened condensed milk, whole milk or the like) or cream and heating the mixture to an initial temperature between about 160° F. and 180° F. (about 71° C. and 82° C.). Such milk-derived components contribute fat to the caramel formulation. Other ingredients which may be utilized in the formulation include, but are not limited to, emulsifiers (e.g., lecithin), vegetable oil, whey, calcium carbonate, salt, molasses and starch. Once any sugars in initial solid form have dissolved and the fats have emulsified, the mixture is heated for a second time to a temperature of about 245° F. (118° C.). Once the desired temperature has been attained, the heating is stopped and the flavorings (e.g., vanilla flavoring, maple flavoring, chocolate flavoring) can be added prior to transferring the caramel mixture to a cooling slab. Depending on consistency, the finished product can be deposited in molds and molded or cut into individual pieces prior to packaging. Extrusion techniques may also be employed.

Alternatively, the sugar components (e.g., the RSCS, the reducing saccharide and sucrose) may be heated separately from the milk-derived components of the reduced sugar caramel to a temperature of, for example, about 165° C. to about 175° C. to caramelize the sugar components before combining with the other ingredients.

Reduced sugar caramels of the present invention are characterized, in various embodiments, as having the desired texture, color, flavor, and over-all organoleptic experience of traditional high-sugar caramels.

Reduced sugar caramels made in accordance with the present invention may be utilized, for example, as caramel candies (e.g., milk caramels, cream caramels, either of which may be enrobed with chocolate or other types of coatings) or as components of other types of food products such as candy bars, caramel corn (popcorn coated in caramel); caramel apples (apples covered with a caramel coating); chocolate confectionaries such as candy bars and the like containing caramel fillings; ice creams, frozen yogurts and other types of frozen dairy products containing caramel variegates; snack bars, granola bars and the like where caramel is used as a binder to agglomerate individual particles of grains, dried fruit, nuts and the like; as well as caramel syrups, sauces and coatings. The reduced sugar caramels of the present invention may be used to add flavor, binding, and/or texture to various types of food products.

The general method for producing a reduced sugar caramel used in the following examples is described below:

Melt butter and mix the ingredients together and heat the mixture to 160-180° F. (71° C.-82° C.) over a low heat. Constantly scrape the sides of the kettle to prevent scorching. Turn off the heat and continue mixing and scraping for 10 minutes to dissolve the sugar and emulsify the fat. Cook the batch to 245° F. (118° C.) over a medium heat. Cooking should take 15-20 minutes to ensure sufficient caramelization. Continue stirring and scraping. As soon as the final temperature is reached, turn off the heat, mix in the flavoring and transfer to a cooling table. Spread the batch out between the bars of the cooling table to form a sheet with a thickness of between 0.5 inches to 0.75 inches (1.3 to 1.9 cm). The target moisture content of the finished product is from 10% to 12%.

The thin-boiling starch utilized in certain embodiments of the present invention may be any of the thin-boiling starches known or used in the confectionary industry, in particular the thin-boiling starches traditionally employed or capable of being employed in the production of jelly gum confectionaries. Combinations of different thin-boiling starches may also be used. Thin-boiling starches are sometimes alternatively referred to as “acid-thinned starches,” “acid-converted starches,” “confectioners starches” or “fluidity starches.” Typically, thin-boiling starches are prepared by treating starch granules in their uncooked state with acid in a process designed to somewhat reduce the molecular weight (i.e., lower the chain length) of the amylose and amylopectin backbones within the granule without disrupting the integrity of the uncooked granules themselves (that is, the acid treatment does not cook out or disrupt the granules at all, which remain in a “cook-up” (insoluble) state after the treatment). The effect of acid treatment is to lower the hot paste viscosity of the starch to a greater extent than it reduces gel strength (molecular weight is decreased, but amylose content remains substantially unchanged). This enables the use of thin-boiling starches at significantly higher levels than is possible using the untreated (unhydrolyzed) parent starch. These characteristics (low viscosity at high starch content) are critical in the processing of jelly gum confectionaries since the concentrated high-starch, high-sugar solution can thereby be rapidly and efficiently cooked without difficulty, thereby facilitating the pumping of the solution and its deposition into molds. Examples of commercially available thin-boiling starches suitable for use in the present invention include Confectioners G starch and the starches supplied by Tate & Lyle under the brand names MERIZET, MIRA-QUIK, MIRA-SET and THINGUM.

The fluidity of the thin-boiling starch or starches selected for use may be varied as may be needed in order to impart the desired characteristics to the jelly gum confectionary. “Fluidity” (sometimes also referred to as “Water Fluidity”) is a term which describes the inverse of viscosity. The higher the fluidity number of a starch, the lower its hot viscosity (i.e., the more fluid it is) and the lower its gel strength (as a result of the lower molecular weight of the starch chains). In one embodiment of the invention, a thin-boiling starch is employed having a fluidity of from about 55 to about 80. In another embodiment, the fluidity of the thin-boiling starch is from about 60 to about 75.

The amount of thin-boiling starch present in the reduced sugar confectionaries of the present invention will vary depending upon the identity and characteristics of the particular thin-boiling starch(es) that is (are) selected, the other components of the confectionary formulation and the desired properties of the formulation and the final confectionary. Typically, however, where the confectionary is a jelly gum confectionary, the confectionary contains from about 5% to about 15% by weight, on a dry weight basis, of thin-boiling starch, based on the total dry weight of the confectionary.

The use of a combination of an RSCS and a thin-boiling starch in the preparation of a confectionary, particularly a jelly gum confectionary, according to one aspect of the present invention offers the advantage of reducing the time required (during a drying operation following the molding or other shaping of a confectionary formulation) to reach a preselected moisture (water) content and/or a preselected firmness level, as compared to the time required for an analogous confectionary formulation wherein a conventional corn syrup rather than an RSCS is employed. This reduction in “drying” time permits productivity in a confectionary manufacturing process to be enhanced and processing costs to be reduced. Thus, RSCS can be used to replace a portion of, or all of, the conventional corn syrup component of a confectionary, in particular a portion of, or all of, the conventional corn syrup component of a jelly gum confectionary additionally comprising a thin-boiling starch. The RSCS and the thin-boiling starch may be pre-blended and combined as a blend with the other components of the jelly gum confectionary (e.g., sucrose) or may be combined as separate ingredients with such other components.

Where the confectionary is a jelly gum confectionary, typically the confectionary may be formulated to contain from about 5% by weight to about 45% by weight, on a dry weight basis, of RSCS. In one embodiment of the invention, the confectionary does not contain any corn syrup in addition to the RSCS. In other embodiments of the invention, an RSCS is present in the confectionary in admixture with one or more additional corn syrups. For example, the weight ratio, on a dry weight basis, of RSCS to other corn syrup may be from 100:0 to 10:90.

Other components may additionally be present in the jelly gum confectionaries of the present invention, including, in particular, sucrose, one or more colorants, one or more flavorants, and/or one or more acidulants. Some amount of water (typically, from about 10% to about 20% by weight or about 14% to about 16%, based on the total weight of the final confectionary) is additionally present. For example, the jelly gum confectionary may contain, on a dry weight basis, from about 20% to about 40% sucrose (this amount being in addition to any sucrose that may be present in the RSCS or optional corn syrup component of the formulation). In one embodiment of the invention, the jelly gum confectionary is comprised of from about 5% to about 15% by weight thin-boiling starch on a dry weight basis, from about 20% to about 40% by weight sucrose on a dry weight basis, from about 10% to about 45% by weight RSCS on a dry weight basis, and from 0% to about 30% by weight conventional corn syrup on a dry weight basis, the total of thin-boiling starch, sucrose, RSCS and conventional corn syrup equaling 100%. Suitable colorants, flavorants and acidulants may be any of such ingredients that are conventionally used, or recognized as being useful, in jelly gum confectionaries, with the amounts used also being in accordance with conventional practice. One or more natural and/or artificial high potency sweeteners may be included to boost the perceived sweetness of the finished confectionary. In addition to the thin-boiling starch, one or more other types of gelatinizing agents known in the confectionary art may be present in the confectionary including, for example, a gelatin, an agar, a gum arabic, a maltodextrin, a dextrin, a pectin (including a modified pectin), a modified starch (other than a thin-boiling starch), an unmodified starch, a high amylose corn starch (modified or unmodified), and the like and combinations thereof.

The jelly gum confectionaries according to one aspect of the present invention may be characterized by a soft jelly-like texture which is tender, yet firm and resilient. The texture may be varied as may be desired to yield products which have a “short” clean bite or which are “long” and somewhat chewy.

Jelly (soft) gum confectionaries capable of being obtained in accordance with various aspects of this invention include, for example, gum drops, spice drops, orange or other fruit-flavored slices, spearmint leaves, jubes, jelly fruits, fruit gums, jelly pastilles, and jelly centers such as jelly bean centers, chocolate centers, cookie centers and the like.

The processing conditions which can be used to make the jelly gum confectionaries described herein may be readily adapted from the processes conventionally known and used in the manufacture of traditional full-sugar jelly gum confectionaries. For example, a batch method of kettle cooking the components of the confectionary may be utilized as well as continuous cookers such as direct steam injection jet cookers or indirect steam tubular heat exchangers (static cookers). Kettle cooking is an atmospheric pressure cooking process, while jet cookers and indirect steam cookers are superatmospheric cookers.

In a kettle cook process, the thin-boiling starch may be first cooked in dilute form (<50% soluble solids) by heating to about 195° F. to about 205° F. (about 91° C. to about 96° C.) and holding approximately five minutes. Then the remaining ingredients (e.g., RSCS, conventional corn syrup (if any) and sucrose) are added and the mixture is boiled until the desired dry solids content (typically about 75% to about 78%) is reached. Any desired colorants, flavorants and/or acidulants are typically added at the conclusion of this boiling step. The boiled mixture is then typically pumped to a depositor, which deposits the boiled mixture into molds of the desired configuration. The boiled mixture should be kept heated, typically above about 190° F. (88° C.) to ensure fluid flow during deposition and prevent tailing. The molds are generally in trays, with the filled trays then being conveyed to drying rooms where they are aged and dried at about 120° F. to about 140° F. for a period of time effective to attain the desired levels of moisture and/or firmness. As previously explained, the presence of RSCS in the confectionary helps to reduce this period of time, as compared to the period of time needed for a confectionary containing a conventional corn syrup instead of the RSCS. The molded confectionaries may then be further aged at ambient (room) temperature for a further period of time (typically, one to two days) before being demolded and subjected to further processing steps if so desired such as sugar sanding, enrobing, coating, surface treatment, packaging and so forth.

A jet cooker may also be used in accordance with the present invention as a way to continuously produce jelly gum confectionaries. The principal difference versus kettle cooking is that the thin-boiling starch is not required to be cooked separately from the other main components (e.g., in the case of one aspect of the present invention, the RSCS and sucrose). The entire confectionary formulation (except for usually the colorant(s), flavorant(s) and acidulant(s)) is processed at superatmospheric pressures at temperatures typically ranging from about 285° F. to about 335° F. (about 141° C. to about 168° C.).

An indirect steam cooker may also be used to process the jelly gum confectionaries of the present invention as a way to continuously produce jelly gum confectionaries without steam directly contacting the product. Indirect steam cookers can reach superatmospheric cooking temperatures and operate by having a mixture of the confectionary components pass through a long metal coil housed in a pressurized steam chamber, thus allowing the product to be exposed to a large heat exchange surface while being held under pressure. In addition to avoiding the contact of live steam with the confectionary, another difference between jet cooking and indirect steam cooking is that indirect cooking results in evaporation of water due to the pressure drop as the hot confectionary mixture exits the cooker. This means that lower solids (higher moisture) formulations can be processed, as compared to jet cooking. Because of this, more moisture is available to cook the thin-boiling starch; lower cooking temperatures can be realized as compared to jet cooking.

The general method for producing a jelly gum confectionary used in the following examples is described below:

Dry blend sugar (sucrose) and thin-boiling starch in a separate container and transfer into a cooking kettle containing a specified amount of water. Transfer the corn syrup(s) and/or RSCS into the kettle while mixing. Cook the slurry to 195° F. with continuous agitation. Adjust steam back pressure valve to 70 psi and set temperature to 285° F. Open the cooking kettle valve, start the pump and run the precooked slurry through a jet cooker at 285° F. Discard water and initial cooked slurry from the collection tank. Collect 1500 g jet-cooked slurry in stainless steel containers for addition of colorant(s), flavorant(s) and acidulant(s). Add acidulant(s), flavorants(s) and colorant(s) as specified and mix thoroughly. Deposit the resulting slurry into molds with the help of metal funnel depositors. Transfer the filled mold trays into a drying oven at 130° F. with air flow. Collect samples after 24 hours or once 84-86 Brix is reached. Cool and package.

### EXAMPLES

### Reference Example 1

### A Method of Producing an RSCS

15 kg of starch slurry (35% DS dent starch) was adjusted to pH 5.8 using 4M NaOH. 5.25 g of Veretase® enzyme (Verenium Corporation) (0.1% w/w starch dsb) was added to the slurry. The slurry was jet cooked at 107° C. (224.6° F.) with a 6-7 min residence time in the tail pipe. The jetted starch was collected and allowed to stir in a round bottom flask maintained at 85-90° C. (185 to 194° F.). Samples were collected for saccharide distribution analysis over time. The reaction was carried out for 3 hours and then killed by reducing the pH to 3 and cooling the syrup. The syrup was then filtered through Celite® and passed through activated carbon and ion exchange resin for purification. The syrup was then evaporated to 80% DS.

Table 1A shows the saccharide distribution of the reaction samples taken at different time intervals. Table 1B provides the molecular weight and polydispersity data for each sample.

TABLE 1A

| Time, min | DP1 | DP2 | DP3 | DP4 | DP5 | DP6 | DP7 | DP8 | DP9 | DP10 | DP11 | DP12 | DP13+ |
|---|---|---|---|---|---|---|---|---|---|---|---|---|---|
| 0 | 0.35 | 3.06 | 3.6 | 2.58 | 2.16 | 4.18 | 6.88 | 5.36 | 5.59 | 4.62 | | | 61.56 |
| 30 | 0.81 | 6.4 | 6.8 | 5.23 | 4.46 | 8.55 | 12.56 | 8.12 | 6.43 | 5.42 | | | 35.17 |
| 60 | 1.4 | 8.94 | 8.73 | 6.84 | 5.97 | 11.62 | 15.39 | 8.14 | 6.03 | 4.63 | 4.43 | 17.78 | |
| 90 | 1.69 | 10.3 | 9.57 | 7.6 | 6.74 | 13.37 | 16.13 | 7.44 | 5.78 | 4.62 | 3.7 | 13.01 | |
| 120 | 1.94 | 11.27 | 10.08 | 8.1 | 7.27 | 14.33 | 16.43 | 6.77 | 5.42 | 3.9 | 14.44 | | |
| 150 | 2.09 | 11.99 | 10.41 | 8.5 | 7.62 | 15.22 | 16.23 | 6.23 | 5.17 | 4.04 | 12.39 | | |
| 180 | 2.3 | 12.64 | 10.73 | 8.79 | 8.03 | 15.8 | 15.92 | 5.93 | 5.11 | 3.81 | 10.82 | | |
| Before | 3.36 | 14.4 | 11.81 | 9.88 | 9.02 | 18.04 | 13.49 | 5.18 | 4.38 | 2.82 | 7.50 | 0.00 | 0.00 |
| GAC | | | | | | | | | | | | | |
| IX | | | | | | | | | | | | | |
| After | 2.81 | 13.7 | 11.49 | 9.75 | 8.96 | 17.83 | 13.55 | 5.45 | 4.67 | 3.21 | 8.51 | 0.00 | 0.00 |
| GAC | | | | | | | | | | | | | |
| IX | | | | | | | | | | | | | |

TABLE 1B

| Time, min | Mₙ | M_{w} | MP | M_{Z} | Polydispersity |
|---|---|---|---|---|---|
| 0 | 1139 | 2025 | 1500 | 3342 | 1.78 |
| 30 | 907 | 1503 | 1334 | 2201 | 1.66 |
| 60 | 807 | 1299 | 1207 | 1840 | 1.61 |
| 90 | 747 | 1198 | 1120 | 1701 | 1.60 |
| 120 | 712 | 1145 | 1045 | 1679 | 1.61 |
| 150 | 681 | 1081 | 1018 | 1540 | 1.59 |
| 180 | 650 | 1030 | 994 | 1452 | 1.59 |
| Final | 684 | 1049 | 1067 | 1425 | 1.53 |
| Final | 648 | 1016 | 1010 | 1403 | 1.57 |

The viscosity profile of the syrup thereby obtained at 71% DS was as shown in Table 2 (compared to SWEETOSE® 4300 63 DE conventional corn syrup, 71% DS).

TABLE 2

| | Temp., ° C. (° F.) | | | | | | |
|---|---|---|---|---|---|---|---|
| | 20 | 30 | 40 | 50 | 60 | 70 | 80 |
| | (68) | (86) | (104) | (122) | (140) | (158) | (176) |
| RSCS | 752 | 358 | 190 | 111 | 71 | 51 | 36 |
| syrup, | | | | | | | |
| viscosity in | | | | | | | |
| cps | | | | | | | |
| SWEETOSE | 586 | 273 | 142 | 81 | 50 | 33 | 24 |
| 4300, | | | | | | | |
| viscosity in | | | | | | | |
| cps | | | | | | | |

### Reference Example 2

### A Method of Producing an RSCS

15 kg of starch slurry (35% DS dent starch) was adjusted to pH 5.3 using 4M NaOH. 5.25 g of Veretase® enzyme (0.1% w/w starch dsb) was added to the slurry. The slurry was jet cooked at 107° C. with a 6-7 min residence time in the tail pipe. The jetted starch was collected and allowed to stir in a round bottom flask maintained at 85-90° C. Samples were collected for saccharide distribution analysis over time. The reaction was carried out for 3 hours and then killed by reducing the pH to 3 and cooling the syrup. The syrup was then filtered through Celite and passed through activated carbon and ion exchange resin for purification. The syrup was then evaporated to 80% DS.

Table 3 shows the saccharide distribution of the reaction samples taken at various times.

TABLE 3

| Time, (min) | Dextrose | DP2 | DP3 | DP4 | DP5 | DP6 | DP7 | DP8 | DP9 | DP10 | DP11 | DP12 | DP13+ |
|---|---|---|---|---|---|---|---|---|---|---|---|---|---|
| 0 | 0.56 | 3.76 | 4.27 | 3.2 | 2.72 | 5.17 | 7.98 | 6.05 | 5.52 | | 5.21 | | 55.7 |
| 30 | 0.98 | 6.43 | 6.81 | 5.28 | 4.59 | 8.8 | 12.23 | 8.09 | 6.47 | 5.2 | 4.38 | | 30.7 |
| 60 | 1.28 | 8.24 | 8.23 | 6.48 | 5.7 | 10.97 | 14.66 | 7.99 | 6.23 | 5.09 | | 4.48 | 20.52 |
| 90 | 1.51 | 9.47 | 9.05 | 7.2 | 6.33 | 12.5 | 15.8 | 7.5 | 5.89 | 4.95 | 3.61 | 16.18 | |
| 120 | 1.7 | 10.57 | 9.68 | 7.78 | 7.04 | 13.78 | 16.15 | 7.08 | 5.53 | 4.77 | 3.46 | 12.53 | |
| 150 | 2.03 | 11.43 | 10.18 | 8.23 | 7.54 | 14.64 | 16.13 | 6.7 | 5.41 | 4.26 | 2.97 | 10.48 | |
| 180 | 2.26 | 12.25 | 10.57 | 8.65 | 7.9 | 15.47 | 15.84 | 6.33 | 5.13 | 4.15 | 3.05 | 8.4 | |
| kill | | | | | | | | | | | | | |
| (pH 3) | | | | | | | | | | | | | |

### Reference Example 3

### A Method of Producing the RSCS

Dent starch (5.25 kg) was mixed with 9.75 kg water to make a 35% DS starch slurry. The pH of the slurry was adjusted to 5.9 using 10% NaOH. 5.25 g of Veretase® enzyme was added to the slurry. The slurry was then jet cooked at 225° F. at a rate of 350 mL/min, which provides a residence time in the tail of 6-7 minutes. The liquefact was collected and cooled to 65° C. (149° F.) in a water bath. After cooling, 10.5 g of Grindamyl® PowerFresh 3001 enzyme (Danisco) was added to the syrup. Samples of the reaction mixture were collected at different time intervals. After 3 hours, the reaction was stopped by reducing the pH to 4. Table 4 shows the saccharide distribution of the reaction samples taken at different times. The time “t=0” is the time at which jetting (liquefaction) had been completed and the Grindamyl® enzyme was added.

By way of comparison, when a typical liquefact prepared by jet cooking a starch slurry using a conventional heat-stable alpha amylase (e.g., those that produce a bimodal product distribution) is reacted with Grindamyl® PowerFresh 3001 enzyme, the reaction product (syrup) obtained has a relatively high content of DP4 saccharide (e.g., somewhat in excess of 40%). However, the product also contains a large proportion of higher oligosaccharides (e.g., about 30% or more DP11+), which adversely affects the viscosity of the syrup. The higher oligosaccharides apparently are not effectively hydrolyzed to lower saccharides by either the Grindamyl® PowerFresh enzyme or the conventional alpha amylase enzyme. The higher oligosaccharides contribute substantially to the viscosity of the syrup and thus the syrup cannot be used to effectively replace higher DE syrups, even though it does have a reduced sugar (DP1+2) content.

TABLE 4

| Sample | Dextrose | DP2 | DP3 | DP4 | DP5 | DP6 | DP7 | DP8 | DP9 | DP10 | DP11 | DP12 | DP13+ |
|---|---|---|---|---|---|---|---|---|---|---|---|---|---|
| Veretase ® | 0.51 | 4.12 | 4.76 | 3.66 | 3.15 | 5.81 | 8.84 | 6.58 | 6.10 | 4.73 | 0.00 | 0.00 | 51.73 |
| Liq | | | | | | | | | | | | | |
| t = 0 | 0.94 | 6.29 | 7.27 | 8.92 | 4.50 | 7.58 | 10.00 | 7.13 | 5.71 | 5.34 | 0.00 | 0.00 | 36.30 |
| t = 0.5 hr | 1.99 | 9.25 | 11.13 | 27.26 | 4.27 | 5.57 | 5.60 | 7.59 | 3.93 | 3.89 | 0.00 | 0.00 | 19.45 |
| t = 1 hr | 2.64 | 10.85 | 12.52 | 34.42 | 3.89 | 4.89 | 4.80 | 6.70 | 3.39 | 3.49 | 2.77 | 0.00 | 9.55 |
| t = 1.5 hr | 3.05 | 11.89 | 13.23 | 37.99 | 3.65 | 4.50 | 4.35 | 5.78 | 3.19 | 2.90 | 9.37 | 0.00 | 0.00 |
| t = 2 hr | 3.33 | 12.58 | 13.55 | 39.76 | 3.52 | 4.30 | 4.12 | 5.20 | 3.11 | 2.64 | 7.80 | 0.00 | 0.00 |
| t = 2.5 hr | 3.62 | 13.31 | 13.84 | 41.04 | 3.42 | 4.11 | 4.01 | 4.68 | 3.02 | 2.18 | 6.65 | 0.00 | 0.00 |
| t = 3 hr | 3.95 | 14.08 | 14.02 | 41.66 | 3.42 | 4.05 | 3.98 | 4.28 | 2.85 | 2.08 | 5.51 | 0.00 | 0.00 |

### Comparative Example 4

A reduced sugar caramel was prepared having the following constituents according to the general method. In this example, a reduced sugar corn syrup containing a small amount of a natural high potency sweetener was used as the RSCS.

| | RSCS without fructose | | |
|---|---|---|---|
| | | | 1000 g |
| Ingredients | wt % | ds | batch |
| Sucrose | 34.60 | 34.60 | 346.00 |
| Krystar ® 300 | 0.00 | 0.00 | 0.00 |
| STALEY 1300 corn syrup | 0.00 | 0.00 | 0.00 |
| SWEETOSE ® 4300 corn | 0.00 | 0.00 | 0.00 |
| syrup | | | |
| RSCS | 36.00 | 27.79 | 360.00 |
| Sweetened Condensed | 24.65 | 17.99 | 246.50 |
| Milk | | | |
| Butter | 3.94 | 3.31 | 39.40 |
| Lecithin | 0.49 | 0.49 | 4.90 |
| Vanilla flavor, liquid | 0.10 | 0.10 | 1.00 |
| Salt | 0.20 | 0.20 | 2.00 |
| TOTAL | 99.98 | 84.49 | 999.80 |

### Example 5

This example is illustrative of a reduced sugar caramel according to the present invention. A reduced sugar caramel was prepared having the following constituents according to the general method. In this example, a reduced sugar corn syrup containing a small amount of a natural high potency sweetener was used as the RSCS and 50 wt % of the sucrose used in Comparative Example 4 was replaced by Krystar® 300 (crystalline fructose)

| | RSCS with fructose | | |
|---|---|---|---|
| | | | 1000 g |
| Ingredients | wt % | Ds | batch |
| Sucrose | 17.31 | 17.31 | 173.10 |
| Krystar ® 300 | 17.31 | 17.31 | 173.10 |
| STALEY 1300 corn syrup | 0.00 | 0.00 | 0.00 |
| SWEETOSE 4300 corn | 0.00 | 0.00 | 0.00 |
| syrup | | | |
| RSCS | 36.00 | 27.79 | 360.00 |
| Sweetened Condensed | 24.65 | 17.99 | 246.50 |
| Milk | | | |
| Butter | 3.94 | 3.31 | 39.40 |
| Lecithin | 0.49 | 0.49 | 4.90 |
| Vanilla flavor, liquid | 0.10 | 0.10 | 1.00 |
| Salt | 0.20 | 0.20 | 2.00 |
| TOTAL | 100.00 | 84.51 | 1000.00 |

The following comparative examples were conducted for the purpose of comparing the reduced sugar caramels from Comparative Example 4 and Example 5 with caramels prepared using traditional, commercially available corn syrups.

### Comparative Example 6

A caramel was prepared having the following constituents according to the general method. In this example, Staley 1300 corn syrup is used together with an RSCS containing a small amount of a natural high potency sweetener.

| | STALEY 1300 | | |
|---|---|---|---|
| | | | 1000 g |
| Ingredients | wt % | Ds | batch |
| Sucrose | 35.10 | 35.10 | 351.00 |
| Krystar ® 300 | 0.00 | 0.00 | 0.00 |
| STALEY 1300 corn syrup | 35.10 | 28.19 | 351.00 |
| SWEETOSE ® 4300 corn | 0.00 | 0.00 | 0.00 |
| syrup | | | |
| RSCS | 0.00 | 0.00 | 0.00 |
| Sweetened Condensed | 25.00 | 18.25 | 250.00 |
| Milk | | | |
| Butter | 4.00 | 3.36 | 40.00 |
| Lecithin | 0.50 | 0.50 | 5.00 |
| Vanilla flavor, liquid | 0.10 | 0.10 | 1.00 |
| Salt | 0.20 | 0.20 | 2.00 |
| TOTAL | 100.00 | 85.70 | 1000.00 |

### Comparative Example 7

A caramel was prepared having the following constituents according to the general method. In this example, Sweetose® 4300 corn syrup is used together with an RSCS containing a small amount of a natural high potency sweetener.

| | SWEETOSE ® 4300 | | |
|---|---|---|---|
| | | | 1000 g |
| Ingredients | wt % | Ds | batch |
| Sucrose | 35.10 | 35.10 | 351.00 |
| Krystar ® 300 | 0.00 | 0.00 | 0.00 |
| STALEY 1300 corn syrup | 0.00 | 0.00 | 0.00 |
| SWEETOSE ® 4300 corn | 34.55 | 28.19 | 345.50 |
| syrup | | | |
| RSCS | 0.00 | 0.00 | 0.00 |
| Sweetened Condensed | 25.00 | 18.25 | 250.00 |
| Milk | | | |
| Butter | 4.00 | 3.36 | 40.00 |
| Lecithin | 0.50 | 0.50 | 5.00 |
| Vanilla flavor, liquid | 0.10 | 0.10 | 1.00 |
| Salt | 0.20 | 0.20 | 2.00 |
| TOTAL | 99.45 | 85.70 | 994.50 |

The target moisture content in the finished products should be between 10% and 12%.

The water activities of the caramels were analyzed at 25° C. to give the following results:

| Caramel Type | Water Activity |
|---|---|
| Staley 1300 | 0.5274 |
| Sweetose 4300 | 0.5093 |
| RSCS without fructose | 0.5289 |
| RSCS with 50 wt % fructose | 0.5006 |

As illustrated in the above results, water activity decreased slightly when 50 wt % of the caramel sucrose content was replaced with fructose. This lower water activity will have a positive impact on the shelf life of the finished product.

### Example 8

This example demonstrates the use of a reduced sugar corn syrup (RSCS) in the preparation of jelly gum confectionaries and its effect on the drying time and drying rate of such confectionaries. Jelly gum confectionaries based on the formulations shown in the following table were prepared according to the general method described previously. All amounts listed are in weight %. The first amount listed for each ingredient is the weight amount based on the total weight of the formulation. The second amount listed (in parentheses) is the DS (Dry Solids) weight amount, i.e., the dry weight amount. Confectioners G and MIRA-SET@ 285 are thin-boiling starches available from Tate & Lyle.

| Ingredients | Control | Test 8-1 | Test 8-2 | Test 8-3 |
|---|---|---|---|---|
| Water | 13.84% | 13.84% | 13.21% | 12.29% |
| STALEY 1300 | 31.60% | 31.60% | 31.60% | — |
| corn syrup | (25.37%) | (25.37%) | (25.37%) | |
| SWEETOSE ® | 13.50% | 13.50% | — | — |
| 4300 corn | (11.02%) | (11.02%) | | |
| syrup | | | | |
| RSCS | — | — | 14.13% | 46.65% |
| | | | (11.02%) | (36.39%) |
| Sucrose | 30.06% | 30.06% | 30.06% | 30.06% |
| | (30.06%) | (30.06%) | (30.06%) | (30.06%) |
| Confectioners | 11.00% | — | — | 11.00% |
| G | (9.68%) | | | (9.68%) |
| MIRA-SET ® | — | 11.00% | 11.00% | — |
| 285 | | (9.68%) | (9.68%) | |
| Total | 100% | 100% | 100% | 100% |
| | (76.13%) | (76.13%) | (76.14%) | (76.13%) |

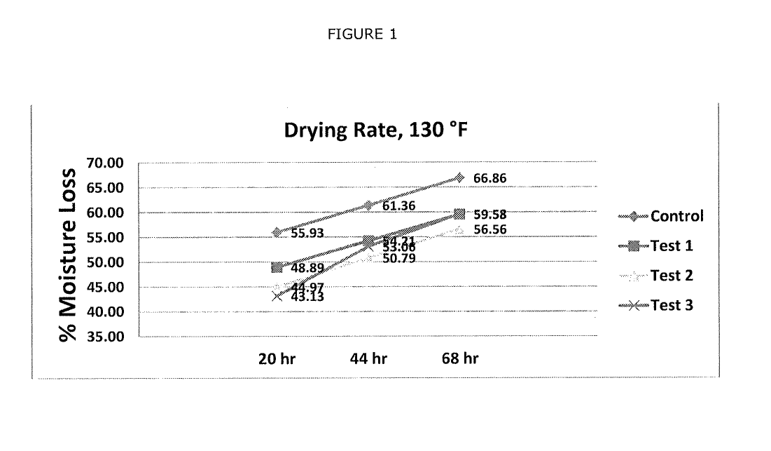

After cooking and molding the jelly gum confectionaries in accordance with the general procedure, the moisture content of samples was measured at 20, 44 and 68 hours during drying at 130° F. The results obtained (% loss of moisture from initial weight) are shown in the following table and illustrated in FIG. 1.

| Formulation | 20 hr | 44 hr | 68 hr |
|---|---|---|---|
| Control | 55.93 | 61.36 | 66.86 |
| Test 8-1 | 48.89 | 54.21 | 59.53 |
| Test 8-2 | 44.97 | 50.79 | 56.56 |
| Test 8-3 | 43.13 | 53.06 | 59.58 |

As is evident from FIG. 1, the jelly gum confectionary formulations in accordance with the present invention (Test 8-2 and Test 8-3) exhibited a faster rate of drying than analogous formulations prepared using only conventional corn syrups as the sweetener syrup component of the formulation (with no reduced sugar corn syrup being present). The faster drying rate was particularly evident for the formulation of Test 8-3, wherein a reduced sugar corn syrup was employed to entirely replace the conventional corn syrups of the Control formulation.

1. A blend comprising a reduced sugar corn syrup (RSCS) and at least one of a reducing saccharide or a thin-boiling starch.

2. The blend of claim 1, wherein the RSCS is a syrup comprising water and saccharides, the saccharides having a saccharide distribution so as to provide a DPI+DP2 content of about 10% to about 30%, a DP3-11 content of about 65% to about 90%, and a DP11+ content of 0% to about 15%, the total equaling 100%.

3. The blend of claim 1, wherein the RSCS comprises water and saccharides, the saccharides having a saccharide distribution of DPI 1-4%; DP2 10-15%; DP3 9-13%; DP4 7-11%; DP5 6-10%; DP6 13-19%; DP7 12-17%; DP8 4-7%; DP9 3-7%; DP10 2-6%; DP11 7-15%; DP11+ 0-4%, the total equaling 100%.

4. The blend of claim 1, additionally comprising at least one natural high potency sweetener.

5. The blend of claim 1, wherein a reducing saccharide is present and the reducing saccharide is fructose.

6. The blend of claim 1, wherein
a thin-boiling starch is present.

7. The blend of claim 6, wherein the thin-boiling starch has a fluidity of from about 55 to about 80.

8. The blend of claim 1, wherein the weight ratio of RSCS to reducing saccharide is from about 50:50 to about 75:25.

9. The blend of claim 1, additionally comprising sucrose,

10. A blend useful for producing a jelly gum confectionary comprising from about 5% to about 15% by weight thin-boiling starch on a dry weight basis, from about 20% to about 40% by weight sucrose on a dry weight basis, from about 10% to about 45% by weight reduced sugar corn syrup (RSCS) on a dry weight basis, and from 0% to about 30% by weight conventional corn syrup on a dry weight basis, the total of thin-boiling starch, sucrose, RSCS and conventional corn syrup equaling 100%.

11. A confectionary comprised of a reduced sugar corn syrup (RSCS), at least one of a reducing saccharide or a thin-boiling starch, and at least one additional food ingredient.

12. The confectionary of claim 11, wherein the confectionary is comprised of at least one reducing saccharide and the confectionary is selected from the group consisting of caramels, chewy confectionaries, bakery and confectionary fillings, flavored syrups, ice cream variegates, and dessert toppings.

13. The confectionary of claim 11, wherein the confectionary is comprised of at least one thin-boiling starch and the confectionary is in the form of a jelly gum.

14. The confectionary of claim 11, wherein the at least one additional food ingredient includes sucrose.

15. A jelly gum confectionary, a caramel, a chewy confectionary, a bakery filling, a confectionary filling, a flavored syrup, an ice cream variegate or a dessert topping made using the blend according to claim 1.

16. A jelly gum confectionary, a caramel, a chewy confectionary, a bakery filling, a confectionary filling, a flavored syrup, an ice cream variegate or a dessert topping made using a reduced sugar corn syrup (RSCS) and at least one of a reducing saccharide or a thin-boiling starch as individual ingredients.

17. A method for the preparation of a reduced sugar caramel comprising heating a mixture comprised of at least one milk-derived ingredient selected from milk, cream or butter and the blend according to claim 1, and/or a mixture of at least one milk-derived ingredient selected from milk, cream or butter with the RSCS and a reducing saccharide as individual ingredients.

18. The method of claim 17, wherein the mixture exhibits a greater degree of caramelization during heating than an analogous mixture not comprising the reducing saccharide.

19. A method of making a jelly gum confectionary, comprising cooking a mixture comprised of a reduced sugar corn syrup, sucrose and a thin-boiling starch to form a cooked slurry, combining at least one food ingredient with the cooked slurry, depositing the cooked slurry into a mold, and drying the cooked slurry deposited in the mold to form the jelly gum confectionary.

20. The method of claim 19, wherein cooking is carried out by jet cooking, kettle cooking, indirect steam cooking or a combination thereof.

21. The method of claim 19, wherein the at least one food ingredient includes at least one ingredient selected from the group consisting of acidulants, flavorants, colorants and combinations thereof.

22. The method of claim 19, wherein the cooked slurry exhibits a drying rate greater than that of an analogous cooked slurry comprised of a conventional corn syrup instead of the reduced sugar corn syrup.

23. (canceled)

24. (canceled)

25. (canceled)
